(19) United States
(12) Patent Application Publication
(10) Pub. No.: US 2017/0008331 A1
(43) Pub. Date: Jan. 12, 2017

(54) STRUCTURE OF WRITING INSTRUMENT

(71) Applicant: Tang-Ning Kuo, New Taipei (TW)

(72) Inventor: Tang-Ning Kuo, New Taipei (TW)

(21) Appl. No.: 15/202,581

(22) Filed: Jul. 6, 2016

(30) Foreign Application Priority Data
Jul. 8, 2015 (TW) 104122124
Jul. 8, 2015 (TW) 104211015

(51) Int. Cl. B43K 25/02; B43K 24/08

(52) U.S. Cl. CPC B43K 25/028; B43K 24/08

(57) ABSTRACT

An improved structure of writing instrument includes a pen body including a pen barrel and an ink refill and tip mounted in the pen barrel, a positioning device including a retaining ring mounted in the pen barrel and a positioning protrusion located at the retaining ring and extended outside the pen barrel, and a pen clip having a clickable top end thereof coupled to the pen body that controls the ink refill and tip between an extended position and a retracted position and an opposing bottom end thereof provided with a U groove that is coupled with the positioning protrusion of the positioning device to guide the pen clip to slide up and down in relation to the positioning protrusion stably and smoothly, and prevent deviation or loosening.

### BACKGROUND OF THE INVENTION

(a) Field of the Invention

The present invention relates to writing instrument technology and more particularly, to a pen-clip-controlled retractable writing instrument.

(b) Description of the Prior Art

Various retractable ballpoint pens and mechanical pencils are known. For example, U.S. Pat. No. 5,413,428 discloses a writing instrument, which comprises a front casing having a through hole extending longitudinally therethrough; a refill extending in the through hole; and a cam body located in the through hole. The cam body has at least one cam groove formed on the inner periphery thereof, at least one cam surface provided at the end thereof, and a shoulder portion connecting the cam grooves. A rotating cam engages the edge of the cam grooves and receives an end of the refill. A cam bar having at least one projection is adapted to be inserted in the cam grooves so as to slide along the cam grooves to a shoulder portion. The cam bar is able to push the rotating cam forwardly to cause the rotating cam to rotate. An elastic body pushes the refill toward the rotating cam. However, because the cam bar simply has the top end thereof inserted into the front casing and the bottom end disposed in contact with the outer surface of the front casing, the bottom end can be shifted sideways and loosened after a long use of the writing instrument. For an advanced and fine writing instrument, it is obviously a design flaw. An improvement in this regard is necessary. Further, in conventional writing instruments, in order for the pen clip to be securely clipped on a sheet of paper or pocket, the pen clip has to have a complicated mounting structure that makes the assembly process difficult and time-consuming. Further, after installation, the pen clip is not easily disassemble for repair. For an advanced and expensive writing instrument, there are deficiencies in terms of design.

### SUMMARY OF THE INVENTION

The present invention has been accomplished under the circumstances in view. It is the main object of the present invention to provide an improved structure of writing instrument, which provides an improved pen clip mounting design, facilitating the mounting of the pen clip, preventing deviation or loosening of the pen clip and enhancing elasticity of the pen clip.

To achieve this and other objects of the present invention, a writing instrument comprises a pen body, a positioning device, and a pen clip. The pen body comprises a pen barrel providing a through hole, and an ink refill and tip inserted in the pen barrel. The positioning device comprises a retaining ring mounted in the pen barrel, and a positioning protrusion attached to the elastic connection of the retaining ring and extended outside the pen barrel through the through hole. The pen clip has a clickable top end thereof coupled to the pen body that controls the ink refill and tip between an extended position and a retracted position, and an opposing bottom end thereof provided with a U groove that is coupled with the positioning protrusion of the positioning device to guide the pen clip to slide up and down in relation to the positioning protrusion stably and smoothly, and prevent deviation or loosening.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a writing instrument in accordance with the present invention.

FIG. 2 is an oblique top elevational view of the writing instrument in accordance with the present invention.

FIG. 3 is an enlarged sectional elevational view of a part of the present invention, illustrating the positioning of the positioning device and the pen clip in the pen body.

FIG. 4 is a schematic sectional side view of the writing instrument in accordance with the present invention.

FIG. 5 corresponds to FIG. 4, illustrating the pen clip pushed down and the compression spring compressed.

FIG. 6 is an exploded view of a part of the present invention, illustrating the relationship between the pen clip, the positioning device, the clip retaining member and the elastic member.

FIG. 7 is a schematic drawing illustrating the clip retaining member and the pen clip fastened together.

FIG. 8 is an oblique top elevational view of the positioning device.

FIG. 9 is an oblique top elevational view of an alternate form of the positioning device.

### DETAILED DESCRIPTION OF THE PREFERRED EMBODIMENTS

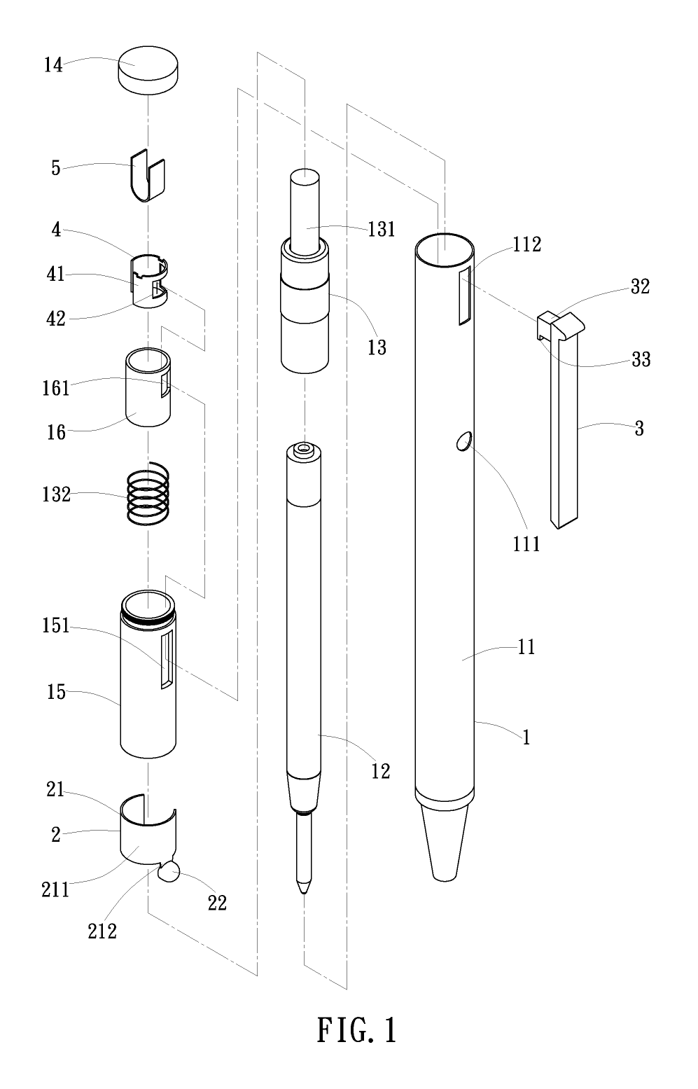

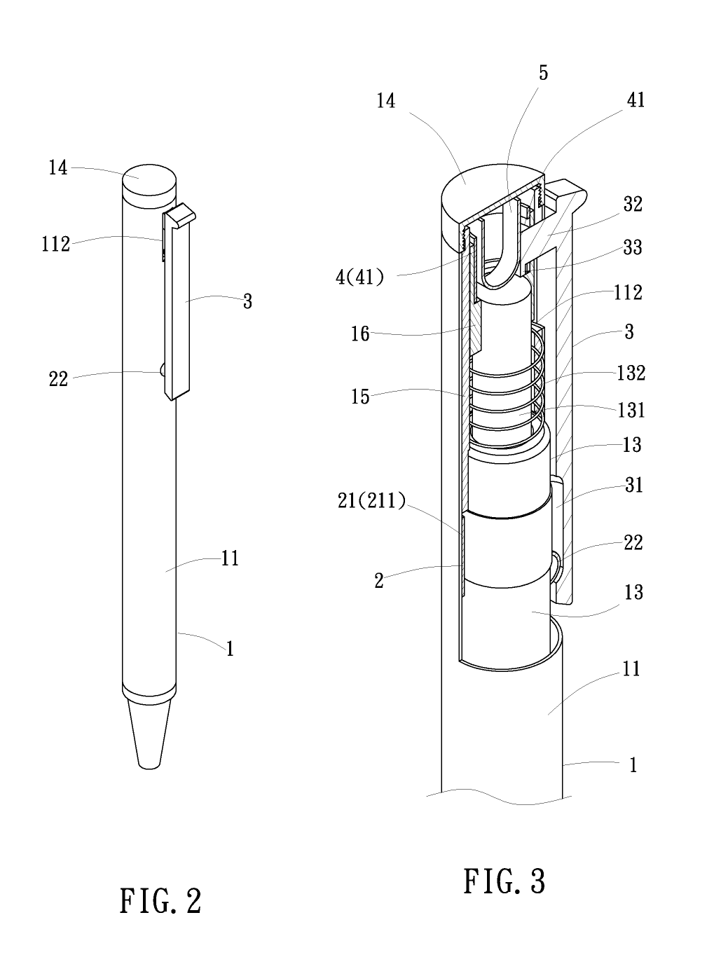

Referring to FIGS. 1-3, an improved structure of writing instrument in accordance with the present invention is shown. The writing instrument in this embodiment is a retractable pen, which enables the ink refill and tip to retract or extend outside the tapered nose when the user pushes the pen clip. The writing instrument comprises a pen body 1, a positioning device 2, and a pen clip 3.

The pen body 1 comprises a pen barrel 11, an ink refill and tip 12 inserted in the pen barrel 11, a spring-loaded retracting mechanism 13 mounted in the pen barrel 11 and stopped at a top end of the ink refill and tip 12 for controlling the ink refill and tip 12 between an extended position and a retracted position, a rear cap 14 capped on an opposing rear open end of the pen barrel 11, a first internal tube 15 mounted in the pen barrel 11 around the spring-loaded retracting mechanism 13 for securing the rear cap 14 in place, and a second internal tube 16 mounted within the first internal tube 15. The spring-loaded retracting mechanism 13 comprises a plunger 131 stopped at the top end of the ink refill and tip 12, and a compression spring 132 stopped between the plunger 131 and the second internal tube 16 and provided for returning the pen clip 3 to its original position. The first internal tube 15 and the second internal tube 16 can be made from metal or plastics. The second internal tube 16 is mounted within the first internal tube 15 for axially holding the spring-loaded retracting mechanism 13 in position. Further, the pen barrel 11 has a through hole 111 cut through the peripheral wall thereof at one side, and a slot on the pen barrel 112 cut through the peripheral wall above the through hole 111. Both The first internal tube 15 and the second internal tube 16 provide a respective slot 151 and 161 corresponding to the slot on the pen barrel 112 of the pen barrel 11 for the assembly of the positioning device 2 and the pen clip 3 respectively.

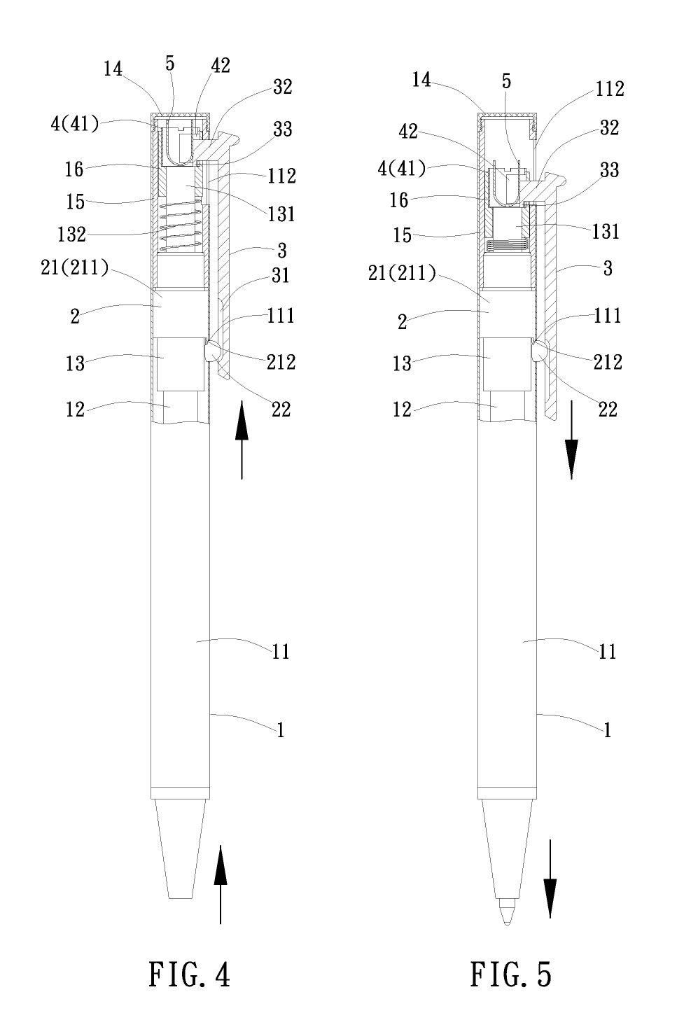

The positioning device 2 is a metal ring member made using sheet metal stamping. As illustrated in FIG. 1, FIG. 3 and FIG. 4, the positioning device 2 comprises a retaining ring 21 mounted in the pen barrel 11, and a positioning protrusion 22 attached to the elastic connection of retaining ring 21 and inserted through the through hole 111 to extend outside the pen barrel 11.

The pen clip 3 is a narrow elongated member, as illustrated in FIG. 1, FIG. 3 and FIG. 5, comprising a base portion 32 located at an inner side of one end thereof and inserted into the slot on the pen barrel 112, the slot on the first internal tube 151 and the slot on the second internal tube 161 (see FIG. 3 and FIG. 4) to abut against the second internal tube 16. Thus, when the user pushes the pen clip 3 downwards, the base portion 32 correspondingly applies the downward pressure to the second internal tube 16 and plunger 131 of the spring-loaded retracting mechanism 13, causing compression spring 132 of the spring-loaded retracting mechanism 13 to provide the tension required to retract or extend the ink refill and tip 12 outside the tapered nose. Further, the pen clip 3 comprises a U groove 31 longitudinally disposed at the inner side thereof at a lower elevation and coupled with the positioning protrusion 22 of the positioning device 2 (see FIG. 3 and FIG. 4). Thus, when the user pushes the pen clip 3, the U groove 31 guides the pen clip 3 to slide up and down in relation to the positioning protrusion 22, and the positioning protrusion 22 ensures the sliding movement of the pen clip 3 stable and smooth, and prevents deviation or loosening.

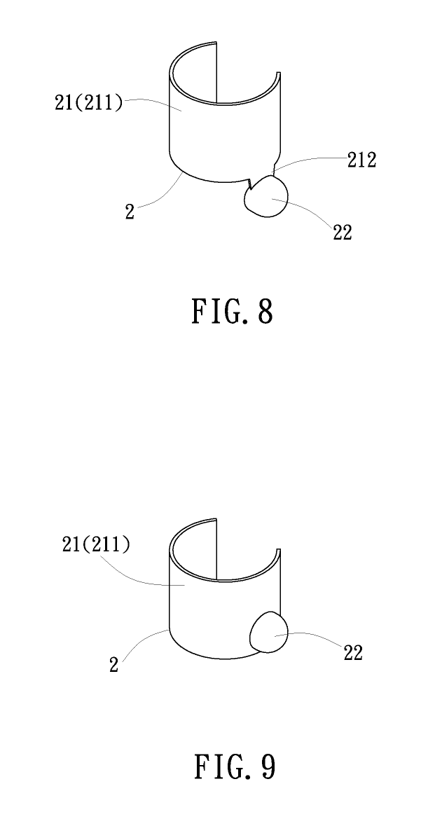

Further, as illustrated in FIG. 1 and FIG. 8, the retaining ring 21 of the positioning device 2 comprises a ring body 211, and a elastic connection 212 formed integral with one end of the ring body 211. The ring body 211 can be configured to provide a circular or C-shaped cross section. The positioning protrusion 22 is located at one side of the elastic connection 212, and configured to provide a semispherical shape. Further, the positioning device 2 can be made of metal using sheet metal stamping. In an alternate form of the present invention, as shown in FIG. 9, the positioning device 2 eliminates the aforesaid elastic connection 212, and the positioning protrusion 22 is directly formed on the periphery of the ring body 211.

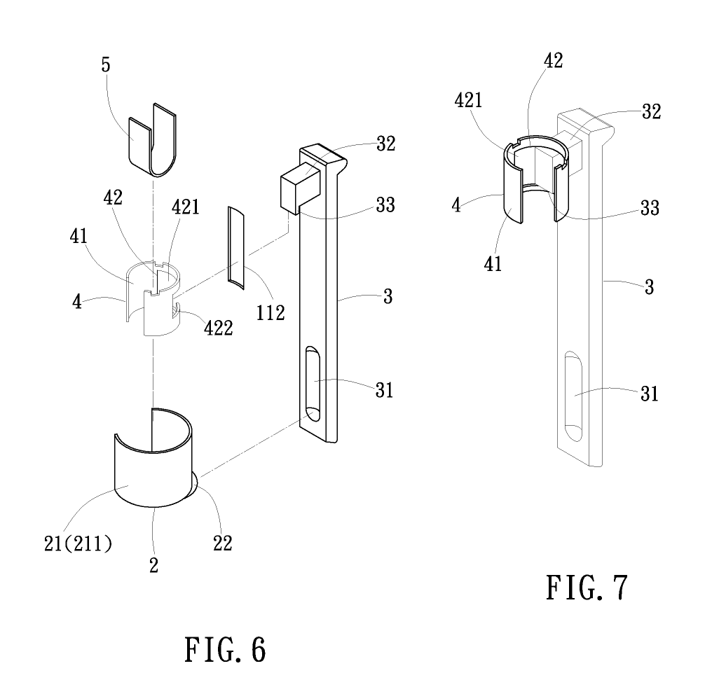

Further, as illustrated in FIG. 1 and FIG. 3, the slot on the pen barrel 112, the slot on the first internal tube 151 and the slot on the second internal tube 161 are provided for the mounting of the pen clip 3. Further, a clip retaining member 4 and an elastic member 5 are mounted in the second internal tube 16 inside the pen barrel 11, enabling the pen clip 3 to be secured to the pen barrel 11. Further, the pen clip 3 is a resilient member that immediately returns to its original position after having been stretched outwards in relation to the pen barrel 11, and thus, the pen clip 3 can be clipped on a sheet of paper or a pocket. As illustrated in FIG. 6, the clip retaining member 4 comprises a clip retaining ring 41, and retaining slots (adjacent to each other) 42 located in the clip retaining ring 41 at one side. The pen clip 3 further comprises a hook portion 33 downwardly disposed at the bottom side of the base portion 32. After insertion of the base portion 32 into the slot on the pen barrel 112, the slot on the first internal tube 151 and the slot on the second internal tube 161, the hook portion 33 is hooked on a bottom edge of the retaining slots (adjacent to each other) 42 of the clip retaining member 4. At this time, the pen clip 3 can be stretched in a direction away from the pen barrel 11. The elastic member 5 is preferably a U-shaped spring inserted in the clip retaining ring 41 with its one end stopped against the clip retaining ring 41 and its other end pressed against the base portion 32 of the pen clip 3 (see FIG. 3), and thus, the pen clip 3 is capable of stretching outwards and recoiling to its original position.

As illustrated in FIG. 6 and FIG. 7, the retaining slots (adjacent to each other) 42 of the clip retaining member 4 is adapted for retaining the top end of the pen clip 3. Preferably, the retaining slots (adjacent to each other) 42 comprises a first retaining slot 421, and a second retaining slot 422 disposed in communication with one side of the first retaining slot 421. Further, the second retaining slot 422 is relatively smaller than the first retaining slot 421. When mounting the pen clip 3, insert the clip retaining member 4 into the pen barrel 11 to keep the first retaining slot 421 in horizontal alignment with the slot on the pen barrel 112, the slot on the first internal tube 151 and the slot on the second internal tube 161, and then insert the base portion 32 of the pen clip 3 into the first retaining slot 421, and then rotate the clip retaining member 4 to force one side edge (the lower edge) of the second retaining slot 422 into engagement with the hook portion 33, and then insert the elastic member 5 in the second internal tube 16. After installation, the free bottom end of the pen clip 3 can be stretched outwards away from the pen barrel 11 to be clipped on a sheet of paper or a pocket securely, or push the pen clip 3 to retract or extend the ink refill and tip 12 outside the tapered nose.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A writing instrument, comprising:
a pen body comprising a pen barrel and an ink refill and tip mounted in said pen barrel, said pen barrel comprising a through hole at one side thereof;
a positioning device comprising a retaining ring mounted in said pen barrel, and a positioning protrusion located at said retaining ring and inserted through said through hole to extend outside of said pen barrel; and
a pen clip having a clickable top end thereof coupled to said pen body that controls said the ink refill and tip between an extended position and a retracted position and an opposing bottom end thereof provided with a U groove, said U groove being coupled with said positioning protrusion of said positioning device to guide said pen clip to slide up and down in relation to said positioning protrusion.

2. The writing instrument as claimed in claim 1, wherein said retaining ring of said positioning device comprises a ring body and a elastic connection extended from said ring body; said positioning protrusion is formed on one side of said elastic connection.

3. The writing instrument as claimed in claim 1, wherein said retaining ring of said positioning device comprises a ring body; said positioning protrusion is formed on one side of said ring body.

4. The writing instrument as claimed in claim 1, wherein said retaining ring of said positioning device is a C-shaped ring; said positioning protrusion has a semispherical shape.

5. The writing instrument as claimed in claim 1, further comprising a clip retaining member and an elastic member mounted inside said pen barrel wherein said pen barrel of said pen body comprises a slot located on one side thereof; said clip retaining member comprises a clip retaining ring and retaining slots (adjacent to each other) located on said clip retaining ring; said pen clip comprises a base portion located at the top end thereof and inserted into said slot on the pen barrel and said retaining slots (adjacent to each other) of said clip retaining member and a hook portion extended from said base portion and hooked on one side of said retaining slots (adjacent to each other); said elastic member is mounted in said clip retaining ring and stopped between said clip retaining ring said base portion of said pen clip.

6. The writing instrument as claimed in claim 5, wherein said retaining slots (adjacent to each other) comprise a first retaining slot and a second retaining slot disposed in communication with one side of said first retaining slot; said clip retaining member is rotatable in relation to said pen barrel and said pen clip to force said second retaining slot into engagement with said hook portion of said pen clip after said base portion of said pen clip is inserted into said first retaining slot.

7. The writing instrument as claimed in claim 6, wherein said elastic member is a U-shaped spring.
